(19) United States
(12) Patent Application Publication
(10) Pub. No.: US 2025/0217256 A1
(43) Pub. Date: Jul. 3, 2025

(54) USER BEHAVIOR RECOGNITION METHOD AND APPARATUS BASED ON SCREEN RECORDING DATA, AND READABLE STORAGE MEDIUM

(71) Applicant: GHAWAR DIGITAL CO., LTD, Shanghai (CN)

(72) Inventors: Chenghao WU, Shanghai (CN); Bo ZHOU, Shanghai (CN)

(21) Appl. No.: 18/766,022

(22) Filed: Jul. 8, 2024

(30) Foreign Application Priority Data
Jan. 3, 2024 (CN) 202410010005.6

(51) Int. Cl. G06F 11/34; G06V 20/40; G06V 30/14

(52) U.S. Cl. CPC G06F 11/3438; G06V 20/46; G06V 30/1456

(57) ABSTRACT

A user behavior recognition method and apparatus based on screen recording data, and a readable storage medium are provided. The method includes: extracting key frames of image from a plurality of frames of image in screen recording data to acquire a plurality of key frames of image; performing data analysis on each key frame of image to extract feature information of each key frame of image; performing picture classification on each key frame of image based on the feature information of each key frame of image to acquire classification information of each key frame of image, wherein the classification information characterizes an operation action performed by a user in the key frame of image; and traversing the classification information of the plurality of key frames of image, and acquiring a user behavior recognition result based on an association among classification information of a plurality of consecutive key frames of image.

### CROSS-REFERENCE TO RELATED APPLICATIONS

This application claims the priority to Chinese Patent Application No. 202410010005.6, filed on Jan. 3, 2024, and entitled “USER BEHAVIOR RECOGNITION METHOD AND APPARATUS BASED ON SCREEN RECORDING DATA, AND READABLE STORAGE MEDIUM”, the entire disclosure of which is incorporated herein.

### TECHNICAL FIELD

The present disclosure generally relates to user behavior recognition technology field, and more particularly, to a user behavior recognition method and apparatus based on screen recording data, and a readable storage medium.

### BACKGROUND

With the development of mobile terminals and network technology, a video of an application operation interface can be recorded through screen recording technology, and user's operations in the screen recording can be determined by combining manual detection and other methods so as to acquire user's operation information from the recorded video. At present, behavioral data including that related to brands, products, advertisements, etc. in a video stream are usually picked out one by one based on manual search and annotation, and user behavior analysis is performed based on the picked behavioral data.

### SUMMARY

Embodiments of the present disclosure may enable to analyze user behaviors efficiently and accurately.

In an embodiment, a user behavior recognition method based on screen recording data is provided, including: extracting key frames of image from a plurality of frames of image in screen recording data to acquire a plurality of key frames of image; performing data analysis on each of the plurality of key frames of image to extract feature information of each of the plurality of key frames of image; performing picture classification on the plurality of key frames of image based on the feature information of each of the plurality of key frames of image to acquire classification information of each of the plurality of key frames of image, wherein the classification information characterizes an operation action performed by a user in the key frame of image; and traversing the classification information of the plurality of key frames of image in the screen recording data, and acquiring a user behavior recognition result based on an association among classification information of a plurality of consecutive key frames of image.

Optionally, said extracting the key frames of image from the plurality of frames of image in the screen recording data includes: comparing picture information of adjacent frames of image in the screen recording data; and in response to a picture information change of the adjacent frames of image having a proportion greater than a preset change threshold, taking a latter frame of image in the adjacent frames of image as a key frame of image.

Optionally, following acquiring the plurality of key frames of image, the method further includes: determining whether a time interval between adjacent key frames of image is longer than a preset shortest time interval; and in response to the time interval between the adjacent key frames of image being not longer than the preset shortest time interval, deleting a latter frame of image in the adjacent key frames of image.

Optionally, said performing data analysis on each of the plurality of key frames of image to extract feature information of each of the plurality of key frames of image includes: in response to the feature information including text feature information, performing optical character recognition on each of the plurality of key frames of image to extract the text feature information in each of the plurality of key frames of image; and/or in response to the feature information including target feature information, performing target detection on each of the plurality of key frames of image to extract the target feature information in each of the plurality of key frames of image.

Optionally, the method further includes: for adjacent key frames of image, calculating a position offset of the text feature information in the adjacent key frames of image; and in response to the position offset being less than a preset offset threshold, deleting a latter frame of image in the adjacent key frames of image.

Optionally, said acquiring the user behavior recognition result based on the association among the classification information of the plurality of consecutive key frames of image includes: the association including a dependence relationship in a time dimension of user operation actions represented by the classification information; and determining the user behavior recognition result based on the dependence relationship in the time dimension of the user operation actions represented by the classification information of the plurality of consecutive key frames of image.

Optionally, a preset behavior sequence is used to represent the dependence relationship of the user operation actions in the time dimension, and includes a plurality of classification information indicating a plurality of consecutive operation actions corresponding to a user behavior, and said determining the user behavior recognition result based on the dependence relationship in the time dimension of the user operation actions represented by the classification information of the plurality of consecutive key frames of image includes: determining whether the classification information of the plurality of consecutive key frames of image matches the preset behavior sequence; and in response to the classification information of the plurality of consecutive key frames of image matching the preset behavior sequence, acquiring the user behavior recognition result based on the user behavior represented by the preset behavior sequence.

Optionally, said determining whether the classification information of the plurality of consecutive key frames of image matches the preset behavior sequence includes: acquiring a preset behavior sequence associated with the traversed classification information of an i-th key frame of image, where i is a positive integer greater than or equal to 1; while traversing to an (i+1)th key frame of image, acquiring a preset behavior sequence associated with the classification information of the (i+1)th key frame of image, and determining whether the classification information of the (i+1)th key frame of image matches the preset behavior sequence associated with the i-th key frame of image; in response to the classification information of the (i+1)th key frame of image matching the preset behavior sequence associated with the i-th key frame of image, retaining the preset behavior sequence associated with the i-th key frame of image, and continuing to match the classification information of the (i+2)th key frame of image with the preset behavior sequence associated with the i-th key frame of image, until the classification information of the plurality of consecutive key frames of image matches the preset behavior sequence associated with the i-th key frame of image, to acquire the user behavior recognition result; and in response to the classification information of the (i+1)th key frame of image not matching the preset behavior sequence associated with the i-th key frame of image, dropping the preset behavior sequence associated with the i-th key frame of image.

Optionally, said acquiring the preset behavior sequence associated with the traversed classification information of the i-th key frame of image includes: matching the classification information of the i-th key frame of image with first classification information in each of multiple preset behavior sequences, and taking the matched preset behavior sequence as the preset behavior sequence associated with the classification information of the i-th key frame of image.

Optionally, prior to said traversing the classification information of the plurality of key frames of image in the screen recording data, the method further includes: filtering the plurality of key frames of image based on the classification information, and taking the key frames of image after the filtering as traversed key frames of image.

Optionally, said filtering the plurality of key frames of image based on the classification information includes: determining whether there are multiple consecutive key frames of image with the same classification information according to a time sequence of the plurality of key frames of image; and in response to there being multiple consecutive key frames of image with the same classification information, retaining one key frame of image among the multiple consecutive key frames of image with the same classification information.

Optionally, the user behavior recognition result includes a duration of the user behavior and/or auxiliary information of the user behavior. The duration of the user behavior is a sum of durations of the plurality of consecutive key frames of image, and the auxiliary information of the user behavior is acquired in the following manner: locating candidate key frames of image from the plurality of consecutive key frames of image based on an operation action of to-be-acquired auxiliary information in the preset behavior sequence and the classification information of the plurality of consecutive key frames of image, and acquiring the auxiliary information based on feature information of the candidate key frames of image.

Optionally, the preset behavior sequence is acquired in the following manner: acquiring an application identifier corresponding to the screen recording data from log information of the screen recording data; and acquiring the preset behavior sequence associated with the application identifier.

In an embodiment, a user behavior recognition apparatus based on screen recording data is provided, including: a key frame extraction circuitry configured to extract key frames of image from a plurality of frames of image in screen recording data to acquire a plurality of key frames of image; a feature information extraction circuitry configured to perform data analysis on each of the plurality of key frames of image to extract feature information of each of the plurality of key frames of image; a classification circuitry configured to perform picture classification on the plurality of key frames of image based on the feature information of each of the plurality of key frames of image to acquire classification information of each of the plurality of key frames of image, wherein the classification information characterizes an operation action performed by a user in the key frame of image; and a user behavior recognition circuitry configured to traverse the classification information of the plurality of key frames of image in the screen recording data, and acquire a user behavior recognition result based on an association among classification information of a plurality of consecutive key frames of image.

In an embodiment of the present disclosure, a non-volatile or non-transitory computer-readable storage medium having computer instructions stored therein is provided, wherein when the computer instructions are executed by a processor, any one of the above user behavior recognition methods based on screen recording data is performed.

In an embodiment of the present disclosure, a user behavior recognition apparatus including a memory and a processor is provided, wherein the memory has computer instructions stored therein, and when the processor executes the computer instructions, any one of the above user behavior recognition methods based on screen recording data is performed.

Embodiments of the present disclosure may provide following advantages.

In embodiments of the present disclosure, key frames of image are extracted from a plurality of frames of image in screen recording data to acquire a plurality of key frames of image, feature information of each of the plurality of key frames of image is extracted, and picture classification is performed on the plurality of key frames of image based on the feature information of each of the plurality of key frames of image to acquire classification information of each of the plurality of key frames of image. As the classification information can be used to characterize operation actions performed by a user in the key frames of image, a user behavior recognition result can be acquired based on an association among the classification information of a plurality of consecutive key frames of image. Using the above method to acquire the user behavior recognition result based on screen recording data may improve efficiency and accuracy of user behavior recognition.

### BRIEF DESCRIPTION OF THE DRAWINGS

FIG. 1 schematically illustrates a flow chart of a user behavior recognition method based on screen recording data according to an embodiment; and

FIG. 2 schematically illustrates a block diagram of a user behavior recognition apparatus based on screen recording data according to an embodiment.

### DETAILED DESCRIPTION

As mentioned above, a traditional method of manually identifying user behaviors in existing techniques requires a lot of labor costs and is low in efficiency. In addition, uneven quality of manual analysis affects accuracy of user behavior analysis results.

To solve the above problem, in embodiments of the present disclosure, key frames of image are extracted from a plurality of frames of image in screen recording data to acquire a plurality of key frames of image, feature information of each of the plurality of key frames of image is extracted, and picture classification is performed on the plurality of key frames of image based on the feature information of each of the plurality of key frames of image to acquire classification information of each of the plurality of key frames of image. As the classification information can be used to characterize operation actions performed by a user in the key frames of image, a user behavior recognition result can be acquired based on an association among the classification information of a plurality of consecutive key frames of image. Using the above method to acquire the user behavior recognition result based on screen recording data may improve efficiency and accuracy of user behavior recognition.

In order to clarify the object, solutions and advantages of embodiments of the present disclosure, embodiments of present disclosure will be described explicitly in detail in conjunction with accompanying drawings.

Embodiments of the present disclosure provide a user behavior recognition method based on screen recording data. The user behavior recognition method may be performed by a terminal device or by a server or cloud platform. The terminal device may include a computer, a laptop, or other suitable terminals.

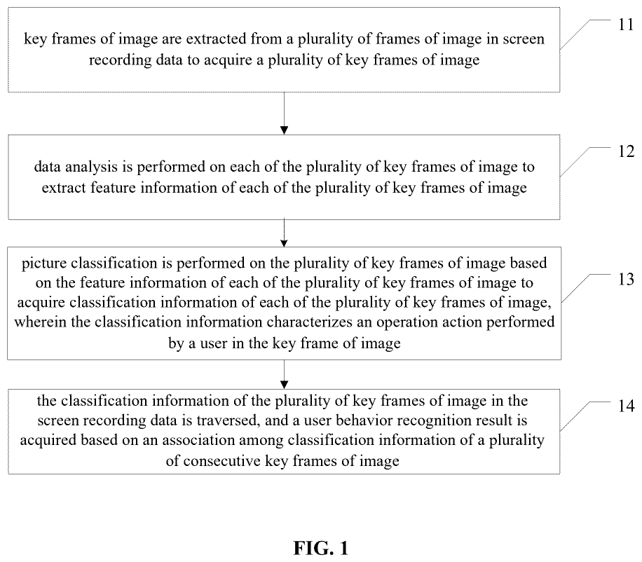

Referring to FIG. 1, the user behavior recognition method based on screen recording data may specifically include following steps 11 to 14.

In 11, key frames of image are extracted from a plurality of frames of image in screen recording data to acquire a plurality of key frames of image.

In 12, data analysis is performed on each of the plurality of key frames of image to extract feature information of each of the plurality of key frames of image.

In 13, picture classification is performed on the plurality of key frames of image based on the feature information of each of the plurality of key frames of image to acquire classification information of each of the plurality of key frames of image, wherein the classification information characterizes an operation action performed by a user in the key frame of image.

In 14, the classification information of the plurality of key frames of image in the screen recording data is traversed, and a user behavior recognition result is acquired based on an association among classification information of a plurality of consecutive key frames of image.

From above, key frames of image are extracted from a plurality of frames of image in screen recording data to acquire a plurality of key frames of image, feature information of each of the plurality of key frames of image is extracted, and picture classification is performed on the plurality of key frames of image based on the feature information of each of the plurality of key frames of image to acquire classification information of each of the plurality of key frames of image. As the classification information can be used to characterize operation actions performed by a user in the key frames of image, a user behavior recognition result can be acquired based on an association among the classification information of a plurality of consecutive key frames of image. Using the above method to acquire the user behavior recognition result based on screen recording data may improve efficiency and accuracy of user behavior recognition.

In addition, the above method may also realize the recognition of the user's coherent actions. Compared with the existing solution that can merely recognize a single operation action, the above method may further improve accuracy of user behavior recognition and reduce a misrecognition rate of user actions.

In some embodiments, one or more application software may be installed on the terminal device. After acquiring user grant and permission, when the user operates the application software on the terminal device, screen recording data is acquired by performing video recording on a screen presented on a user interface of the terminal device.

The screen recording data may be split into a plurality of consecutive frames of image.

In some embodiments, in 11, a following method is used to extract the key frames of image from the plurality of frames of image in the screen recording data. Specifically, picture information of adjacent frames of image in the screen recording data is compared, and in response to a picture information change of the adjacent frames of image having a proportion greater than a preset change threshold, a latter frame of image in the adjacent frames of image is taken as a key frame of image. The preset change threshold may be configured based on factors such as processing capability of the terminal device or tolerance for information loss. The higher the preset change threshold, the greater the change in the picture information of the adjacent key frames of image, and the more picture information is lost in the extracted key frames of image compared to the picture information included in the screen recording data. In this case, the acquired key frames of image are relatively few, the lower the processing capability required on the terminal, and the higher the tolerance for information loss. Accordingly, the lower the preset change threshold, the picture information of the adjacent key frames of image changes relatively little, and the less picture information is lost in all extracted key frames of image compared to the picture information included in the screen recording data.

Generally, when extracting the key frames of image based on the change in picture information, the tolerance for information loss is relatively low, that is, the similarity between adjacent key frames of image is relatively large. However, during user behavior recognition, the user's operation actions usually last for a certain period of time, thus, it is usually impossible to produce multiple effective operations in a short period of time.

To improve effectiveness of the extracted key frames of image in user behavior recognition and extraction efficiency of the key frames of image, in some embodiments, after the key frames of image are extracted, the key frames of image may further be filtered. For example, whether a time interval between adjacent key frames of image is longer than a preset shortest time interval is determined, and in response to the time interval between the adjacent key frames of image being not longer than the preset shortest time interval, a latter frame of image in the adjacent key frames of image is deleted.

In some embodiments, the application identifier corresponding to the screen recording data is acquired, and a minimum time interval is determined based on the application identifier. The application identifier is used to represent an application software corresponding to the screen recording data. Different application identifiers have corresponding minimum time intervals, and the minimum time intervals corresponding to different application identifiers may be different.

In some embodiments, the application identifier corresponding to the screen recording data may be acquired from log information of the screen recording data.

In some embodiments, after the plurality of key frames of image are extracted, the plurality of key frames of image may be marked based on positions of the plurality of key frames of image in the screen recording data to identify a relative position sequence of the plurality of key frames of image. The marking may include numbering the plurality of key frames of image. Alternatively, the time of the key frames of image in the screen recording data may be used as marking information.

In some embodiments, in 12, the feature information of each key frame pf image may include at least one of the following: text feature information and target feature information.

In some embodiments, Optical Character Recognition (OCR) is performed on each key frame of image to extract text feature information in each key frame of image.

In some embodiments, the text feature information may include text content information, location information of the text content in the key frame of image, etc. For adjacent key frames of image, a position offset of the text feature information in the adjacent key frames of image is calculated. If the position offset is less than a preset offset threshold, a latter key frame of image in the adjacent key frames of image is deleted. The text feature information can characterize information associated with the user behavior carried in the key frame of image. When the position offset of the text feature information in the adjacent key frames of image is small, it indicates that a difference between the two adjacent key frames of image is relatively small. Therefore, deleting the latter key frame of image not only ensures the accuracy of user behavior recognition, but also achieves simplification of the key frames of image and improves the efficiency of user behavior.

For example, the text content information may include one or more of product value, product name, name of each navigation bar included in a page navigation page, name of a button, etc. It should be noted that in different application scenarios, specific content included in the text content information is different, which is not limited here.

In some embodiments, for the adjacent key frames of image, it is determined whether the text content information in the text feature information in the two adjacent key frames of image is the same. If the text content information is the same, a position offset of the same text feature information is calculated. If the position offset is less than the preset offset threshold, the latter key frame of image in the adjacent key frames of image is deleted.

In some embodiments, target detection is performed on each key frame of image, and target feature information in each key frame of image is extracted. The target feature information may be brand information, product information, etc. The product information may include a product image.

In some embodiments, the position offset of the text feature information in the adjacent key frames of image may be calculated. If the position offset is less than the preset offset threshold, the latter key frame of image in the adjacent key frames of image is deleted. After the plurality of key frames of image are filtered, target detection is performed on the plurality of key frames of image, and target feature information is extracted from each key frame of image.

In some embodiments, after extracting the feature information of each key frame of image, an association between the key frame of image and the feature information is established, and the feature information of the key frame of image and the association between the key frame of image and the feature information may be saved.

In some embodiments, the classification information is used to characterize operation actions performed by the user in the key frames of image. Depending on different application scenario, the application software corresponding to the screen recording data is different, and the operations performed by the user in the key frames of image are different. Taking shopping application software, such as Taobao and JD.com, as an example, the operations performed by the user in the key frames of image may include browsing products, entering product details pages, adding to shopping carts, submitting orders, paying orders, etc. Each type of classification information corresponds to one or more types of feature information, and an association between the classification information and the feature information may be configured. Subsequently, picture classification may be performed on the key frames of image based on each key frame of image, text, position and other feature information.

The classification information of each key frame of image may include one type or multiple types.

The association includes a dependence relationship in a time dimension of user operation actions represented by the classification information. The dependence relationship in a time dimension may represent that the user operation actions represented by the classification information of adjacent key frames of image have a sequence relation in the time dimension. For example, the user operation action represented by the classification information of the latter key frame of image depends on the user operation action represented by the classification information of the former key frame of image.

In some embodiments, a preset behavior sequence is used to represent the dependence relationship of the user operation actions in the time dimension, and includes a plurality of classification information indicating a plurality of consecutive operation actions corresponding to a user behavior.

Multiple preset behavior sequences may be provided. The preset behavior sequence is acquired in the following manner: acquiring an application identifier corresponding to the screen recording data from log information of the screen recording data; and acquiring the preset behavior sequence associated with the application identifier. The application identifier is used to identify the application software and corresponds to the application software in a one-to-one correspondence. The application identification may be numbering of the application software, a name of the application software, etc.

In some embodiments, in 14, whether the classification information of the plurality of consecutive key frames of image matches the preset behavior sequence is determined, and in response to the classification information of the plurality of consecutive key frames of image matching the preset behavior sequence, the user behavior recognition result is acquired based on the user behavior represented by the preset behavior sequence.

In some embodiments, each user behavior may correspond to one or more preset behavior sequences. When performing user behavior recognition, the acquired preset behavior sequence may be a set behavior sequence of one user behavior, or may be a set behavior sequence of multiple user behaviors. Taking each set behavior sequence as a link, when performing user behavior recognition, the classification information of each key frame of image may be matched with the set behavior sequence of each link one by one, or the classification information of each key frame of image may be matched with the set behavior sequences of all links simultaneously.

In some embodiments, while traversing the classification information of the plurality of key frames of image in the screen recording data, a preset behavior sequence associated with the traversed classification information of the i-th key frame of image is acquired, where i is a positive integer greater than or equal to 1. While traversing to the (i+1)th key frame of image, a preset behavior sequence associated with the classification information of the (i+1)th key frame of image is acquired, and whether the classification information of the (i+1)th key frame of image matches the preset behavior sequence associated with the i-th key frame of image is determined. In response to the classification information of the (i+1)th key frame of image matching the preset behavior sequence associated with the i-th key frame of image, the preset behavior sequence associated with the i-th key frame of image is retained, and the classification information of the (i+2)th key frame of image continues to be matched with the preset behavior sequence associated with the i-th key frame of image, until the classification information of the plurality of consecutive key frames of image matches the preset behavior sequence associated with the i-th key frame of image, to acquire the user behavior recognition result. In response to the classification information of the (i+1)th key frame of image not matching the preset behavior sequence associated with the i-th key frame of image, the preset behavior sequence associated with the i-th key frame of image is dropped.

At the same time, while traversing to the (i+1)th key frame of image, the preset behavior sequence associated with the classification information of the (i+1)th key frame of image is acquired. While traversing to the (i+2)th key frame of image, whether the classification information of the (i+2)th key frame of image matches the preset behavior sequence associated with the (i+1)th key frame of image is determined. In response to the classification information of the (i+2)th key frame of image matching the preset behavior sequence associated with the (i+1)th key frame of image, the preset behavior sequence associated with the (i+1)th key frame of image is retained, and the classification information of the (i+3)th key frame of image continues to be matched with the preset behavior sequence associated with the (i+1)th key frame of image, until the classification information of the plurality of consecutive key frames of image matches the preset behavior sequence associated with the (i+1)th key frame of image, to acquire the user behavior recognition result. In response to the classification information of the (i+2)th key frame of image not matching the preset behavior sequence associated with the (i+1)th key frame of image, the preset behavior sequence associated with the (i+1)th key frame of image is dropped.

In some embodiments, the classification information of the i-th key frame of image is matched with first classification information in each of multiple preset behavior sequences, and the matched preset behavior sequence is taken as the preset behavior sequence associated with the classification information of the i-th key frame of image.

If there are multiple types of classification information for the i-th key frame of image, each type of classification information is matched with the first classification information in each of the multiple preset behavior sequences, and the matched preset behavior sequence is taken as the preset behavior sequence associated with the classification information of the i-th key frame of image. The preset behavior sequence associated with the classification information of the i-th key frame of image may include one or multiple preset behavior sequences.

In some embodiments, prior to said traversing the classification information of the plurality of key frames of image in the screen recording data, the method further includes: filtering the plurality of key frames of image based on the classification information, and taking the key frames of image after the filtering as traversed key frames of image.

In some embodiments, the plurality of key frames of image may be filtered based on the classification information in the following manner. Specifically, whether there are multiple consecutive key frames of image with the same classification information is determined according to a time sequence of the plurality of key frames of image. In response to there being multiple consecutive key frames of image with the same classification information, one key frame of image among the multiple consecutive key frames of image with the same classification information is retained. For example, the first or last key frame of image among the multiple consecutive key frames of image is retained, or any key frame of image among the multiple consecutive key frames of image is retained. The plurality of key frames of image after the filtering based on the classification information are used as to-be-traversed key frames of image. In this way, filtering the key frames of image based on the classification information and traversing based on the key frames of image after the filtering may avoid repeatedly matching the same preset behavior sequence on the key frames of image with the same classification information, or matching some pages that have nothing to do with classification information (such as blank pages, or staying on one key frame of image due to network delay), which improves matching efficiency.

In some embodiments, if a plurality of consecutive key frames of image with the same classification information include key frames of image with multiple types of classification information, the key frames of image with multiple types of classification information are retained.

In some embodiments, the user behavior recognition result further includes a duration of the user behavior and/or auxiliary information of the user behavior.

In some embodiments, the duration of the user behavior is a sum of durations of the plurality of consecutive key frames of image.

In some embodiments, the auxiliary information of the user behavior is acquired in the following manner: locating candidate key frames of image from the plurality of consecutive key frames of image based on an operation action of to-be-acquired auxiliary information in the preset behavior sequence and the classification information of the plurality of consecutive key frames of image, and acquiring the auxiliary information based on feature information of the candidate key frames of image.

The auxiliary information may include information about an object related to the user behavior. For example, if the user behavior is to place an order, the information about the object related may be a product name, product quantity or product amount of the order, etc. For another example, if the user behavior is to browse a page, the information about the object related may be a name of the page browsed, a browsing time, or changing a browsing entrance, etc.

Further, an association between an acquisition rule of auxiliary information and the user behavior. The acquisition rule of the auxiliary information may be used to indicate classification information where the auxiliary information appears. After determining the user behavior in the screen recording data, the acquisition rule of the auxiliary information is acquired, candidate key frames of image are determined based on the acquisition rule of the auxiliary information and the classification information of each key frame of image, and the auxiliary information is acquired from feature information of the candidate key frames of image.

In some embodiments, the user behavior recognition result may save as a data set.

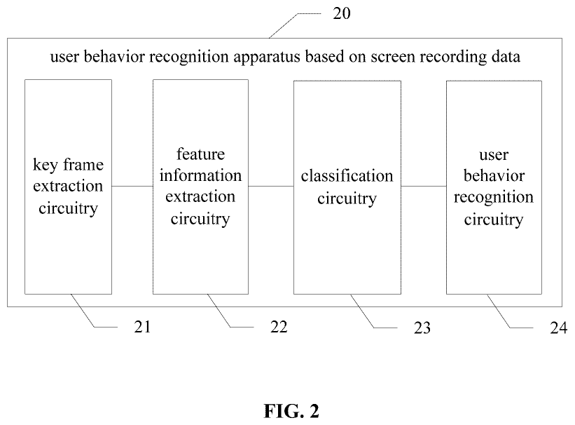

Referring to FIG. 2, FIG. 2 schematically illustrates a block diagram of a user behavior recognition apparatus based on screen recording data according to an embodiment. The user behavior recognition apparatus 20 includes: a key frame extraction circuitry 21 configured to extract key frames of image from a plurality of frames of image in screen recording data to acquire a plurality of key frames of image; a feature information extraction circuitry 22 configured to perform data analysis on each of the plurality of key frames of image to extract feature information of each of the plurality of key frames of image; a classification circuitry 23 configured to perform picture classification on the plurality of key frames of image based on the feature information of each of the plurality of key frames of image to acquire classification information of each of the plurality of key frames of image, wherein the classification information characterizes an operation action performed by a user in the key frame of image; and a user behavior recognition circuitry 24 configured to traverse the classification information of the plurality of key frames of image in the screen recording data, and acquire a user behavior recognition result based on an association among classification information of a plurality of consecutive key frames of image.

In some embodiments, the user behavior recognition apparatus 20 may be used to implement the above user behavior recognition method. The user behavior recognition apparatus 20 may include units for implementing each step in the user behavior recognition method. Detailed working principles and working procedures of the user behavior recognition apparatus 20 may be referred to descriptions of the user behavior recognition method in the above embodiments, and are not repeated here.

In an embodiment of the present disclosure, a computer-readable storage medium having computer instructions stored therein is provided, wherein when the computer instructions are executed by a processor, the user behavior recognition method based on screen recording data provided in any one of the above embodiments is performed.

The computer-readable storage medium may include a non-volatile or non-transitory storage medium, or include a compact disc, a hard disk drive or a solid-state drive.

In an embodiment of the present disclosure, a user behavior recognition apparatus based on screen recording data including a memory and a processor is provided, wherein the memory has computer instructions stored therein, and when the processor executes the computer instructions, the user behavior recognition method based on screen recording data provided in any one of the above embodiments is performed.

The memory and the processor are coupled, where the memory may be disposed inside or outside the user behavior recognition apparatus based on screen recording data. The memory and the processor may be coupled via a communication bus.

The user behavior recognition apparatus based on screen recording data may include but not limited to a mobile phone, a computer, a tablet computer or other terminal devices, or may be a server or a cloud platform.

The above embodiments may be implemented in whole or in part by software, hardware, firmware or any combination thereof. When implemented in software, the above embodiments may be implemented in whole or in part in the form of a computer program product. The computer program product includes one or more computer instructions or computer programs. The procedures or functions according to the embodiments of the present disclosure are wholly or partially generated when the computer instructions or the computer programs are loaded or executed on a computer. The computer may be a general-purpose computer, a special purpose computer, a computer network, or other programmable device. The computer instructions may be stored in a computer readable storage medium or transmitted from one computer readable storage medium to another computer readable storage medium, for example, the computer instructions may be transmitted from one website, computer, server or data center to another website, computer, server or data center in a wired or wireless manner.

In the above embodiments of the present disclosure, it should be understood that the disclosed method, device and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

It should be understood that the term “and/or” in the present disclosure is merely an association relationship describing associated objects, indicating that there can be three types of relationships, for example, A and/or B can represent three situations including “A exists only”, “both A and B exist”, and “B exists only”. In addition, the character “/” in the present disclosure represents that the former and latter associated objects have an “or” relationship.

The “plurality” in the embodiments of the present disclosure refers to two or more.

It should be understood that, in the various embodiments of the present disclosure, sequence numbers of the above-mentioned processes do not represent an execution sequence of each process.

Although the present disclosure has been disclosed above with reference to preferred embodiments thereof, it should be understood that the disclosure is presented by way of example merely, and not limitation. Those skilled in the art can modify and vary the embodiments without departing from the spirit and scope of the present disclosure.

What is claimed is:

1. A user behavior recognition method based on screen recording data, comprising:
extracting key frames of image from a plurality of frames of image in screen recording data to acquire a plurality of key frames of image;
performing data analysis on each of the plurality of key frames of image to extract feature information of each of the plurality of key frames of image;
performing picture classification on the plurality of key frames of image based on the feature information of each of the plurality of key frames of image to acquire classification information of each of the plurality of key frames of image, wherein the classification information characterizes an operation action performed by a user in the key frame of image; and
traversing the classification information of the plurality of key frames of image in the screen recording data, and acquiring a user behavior recognition result based on an association among classification information of a plurality of consecutive key frames of image.

2. The method according to claim 1, wherein said extracting the key frames of image from the plurality of frames of image in the screen recording data comprises:
comparing picture information of adjacent frames of image in the screen recording data; and
in response to a picture information change of the adjacent frames of image having a proportion greater than a preset change threshold, taking a latter frame of image in the adjacent frames of image as a key frame of image.

3. The method according to claim 1, wherein following acquiring the plurality of key frames of image, the method further comprises:
determining whether a time interval between adjacent key frames of image is longer than a preset shortest time interval; and
in response to the time interval between the adjacent key frames of image being not longer than the preset shortest time interval, deleting a latter frame of image in the adjacent key frames of image.

4. The method according to claim 1, wherein said performing data analysis on each of the plurality of key frames of image to extract feature information of each of the plurality of key frames of image comprises:
in response to the feature information comprising text feature information, performing optical character recognition on each of the plurality of key frames of image to extract the text feature information in each of the plurality of key frames of image; and/or
in response to the feature information comprising target feature information, performing target detection on each of the plurality of key frames of image to extract the target feature information in each of the plurality of key frames of image.

5. The method according to claim 4, further comprising:
for adjacent key frames of image, calculating a position offset of the text feature information in the adjacent key frames of image; and
in response to the position offset being less than a preset offset threshold, deleting a latter frame of image in the adjacent key frames of image.

6. The method according to claim 1, wherein said acquiring the user behavior recognition result based on the association among the classification information of the plurality of consecutive key frames of image comprises:
the association comprising a dependence relationship in a time dimension of user operation actions represented by the classification information; and
determining the user behavior recognition result based on the dependence relationship in the time dimension of the user operation actions represented by the classification information of the plurality of consecutive key frames of image.

7. The method according to claim 6, wherein a preset behavior sequence is used to represent the dependence relationship of the user operation actions in the time dimension, and comprises a plurality of classification information indicating a plurality of consecutive operation actions corresponding to a user behavior, and said determining the user behavior recognition result based on the dependence relationship in the time dimension of the user operation actions represented by the classification information of the plurality of consecutive key frames of image comprises:
determining whether the classification information of the plurality of consecutive key frames of image matches the preset behavior sequence; and
in response to the classification information of the plurality of consecutive key frames of image matching the preset behavior sequence, acquiring the user behavior recognition result based on the user behavior represented by the preset behavior sequence.

8. The method according to claim 7, wherein said determining whether the classification information of the plurality of consecutive key frames of image matches the preset behavior sequence comprises:
acquiring a preset behavior sequence associated with the traversed classification information of an i-th key frame of image, where i is a positive integer greater than or equal to 1;
while traversing to an (i+1)th key frame of image, acquiring a preset behavior sequence associated with the classification information of the (i+1)th key frame of image, and determining whether the classification information of the (i+1)th key frame of image matches the preset behavior sequence associated with the i-th key frame of image;
in response to the classification information of the (i+1)th key frame of image matching the preset behavior sequence associated with the i-th key frame of image, retaining the preset behavior sequence associated with the i-th key frame of image, and continuing to match the classification information of the (i+2)th key frame of image with the preset behavior sequence associated with the i-th key frame of image, until the classification information of the plurality of consecutive key frames of image matches the preset behavior sequence associated with the i-th key frame of image, to acquire the user behavior recognition result; and
in response to the classification information of the (i+1)th key frame of image not matching the preset behavior sequence associated with the i-th key frame of image, dropping the preset behavior sequence associated with the i-th key frame of image.

9. The method according to claim 8, wherein said acquiring the preset behavior sequence associated with the traversed classification information of the i-th key frame of image comprises:
matching the classification information of the i-th key frame of image with first classification information in each of multiple preset behavior sequences, and taking the matched preset behavior sequence as the preset behavior sequence associated with the classification information of the i-th key frame of image.

10. The method according to claim 1, wherein prior to said traversing the classification information of the plurality of key frames of image in the screen recording data, the method further comprises:
filtering the plurality of key frames of image based on the classification information, and taking the key frames of image after the filtering as traversed key frames of image.

11. The method according to claim 10, wherein said filtering the plurality of key frames of image based on the classification information comprises:
determining whether there are multiple consecutive key frames of image with the same classification information according to a time sequence of the plurality of key frames of image; and
in response to there being multiple consecutive key frames of image with the same classification information, retaining one key frame of image among the multiple consecutive key frames of image with the same classification information.

12. The method according to claim 8, wherein prior to said traversing the classification information of the plurality of key frames of image in the screen recording data, the method further comprises:
filtering the plurality of key frames of image based on the classification information, and taking the key frames of image after the filtering as traversed key frames of image.

13. The method according to claim 12, wherein said filtering the plurality of key frames of image based on the classification information comprises:
determining whether there are multiple consecutive key frames of image with the same classification information according to a time sequence of the plurality of key frames of image; and
in response to there being multiple consecutive key frames of image with the same classification information, retaining one key frame of image among the multiple consecutive key frames of image with the same classification information.

14. The method according to claim 7, wherein the user behavior recognition result comprises a duration of the user behavior and/or auxiliary information of the user behavior,
the duration of the user behavior is a sum of durations of the plurality of consecutive key frames of image, and
the auxiliary information of the user behavior is acquired in the following manner: locating candidate key frames of image from the plurality of consecutive key frames of image based on an operation action of to-be-acquired auxiliary information in the preset behavior sequence and the classification information of the plurality of consecutive key frames of image, and acquiring the auxiliary information based on feature information of the candidate key frames of image.

15. The method according to claim 7, wherein the preset behavior sequence is acquired in the following manner:
acquiring an application identifier corresponding to the screen recording data from log information of the screen recording data; and
acquiring the preset behavior sequence associated with the application identifier.

16. A non-volatile or non-transitory computer-readable storage medium having computer instructions stored therein, wherein when the computer instructions are executed by a processor, the method of claim 1 is performed.

17. A user behavior recognition apparatus comprising a memory and a processor, wherein the memory stores one or more programs, the one or more programs comprising computer instructions, which, when executed by the processor, cause the processor to:
extract key frames of image from a plurality of frames of image in screen recording data to acquire a plurality of key frames of image;
perform data analysis on each of the plurality of key frames of image to extract feature information of each of the plurality of key frames of image;
perform picture classification on the plurality of key frames of image based on the feature information of each of the plurality of key frames of image to acquire classification information of each of the plurality of key frames of image, wherein the classification information characterizes an operation action performed by a user in the key frame of image; and
traverse the classification information of the plurality of key frames of image in the screen recording data, and acquire a user behavior recognition result based on an association among classification information of a plurality of consecutive key frames of image.

18. The apparatus according to claim 17, wherein the processor is further caused to:
compare picture information of adjacent frames of image in the screen recording data; and
in response to a picture information change of the adjacent frames of image having a proportion greater than a preset change threshold, take a latter frame of image in the adjacent frames of image as a key frame of image.

19. The apparatus according to claim 17, wherein the processor is further caused to:
following acquiring the plurality of key frames of image, determine whether a time interval between adjacent key frames of image is longer than a preset shortest time interval; and
in response to the time interval between the adjacent key frames of image being not longer than the preset shortest time interval, delete a latter frame of image in the adjacent key frames of image.

20. The apparatus according to claim 17, wherein the processor is further caused to:
in response to the feature information comprising text feature information, perform optical character recognition on each of the plurality of key frames of image to extract the text feature information in each of the plurality of key frames of image; and/or
in response to the feature information comprising target feature information, perform target detection on each of the plurality of key frames of image to extract the target feature information in each of the plurality of key frames of image.
